(19) United States
(12) Patent Application Publication
(10) Pub. No.: US 2009/0178579 A1
(43) Pub. Date: Jul. 16, 2009

(54) SELF-CLEANING ROTISSERIE OVEN INCLUDING OVEN DOOR WITH LABYRINTH SEAL

(76) Inventors: James M. Heiser, Hillsboro, OH (US); Richard D. Valentine, Hillsboro, OH (US); Matthew A. Weber, Springboro, OH (US); Scott A. Mullenix, Hillsboro, OH (US)

Correspondence Address: THOMPSON HINE LLP;Intellectual Property Group, P.O Box 8801, DAYTON, OH, 45401-8801, US

(21) Appl. No.: 12/324,333

(22) Filed: Nov. 26, 2008

Related U.S. Application Data
(60) Provisional application No. 61/021,130, filed on Jan. 15, 2008.

(51) Int. Cl. A47J 37/04; F24C 15/00

(52) U.S. Cl. 99/421 H; 126/19 R

(57) ABSTRACT

A self-cleaning rotisserie oven including an oven cabinet including an internal cooking chamber with an access opening. The oven cabinet includes an access opening frame about the access opening. A self-cleaning system is provided for cleaning the cooking chamber with a liquid. A rotor is located within the cooking chamber. A door is mounted on the oven cabinet. The door spanning the access opening with the door in a closed configuration and providing access to the cooking chamber when in an open configuration. With the door in the closed configuration, the door including a plate extending inwardly toward the oven chamber. The plate is located to an interior side of a lip extending outwardly from the access opening frame and toward the door thereby defining a tortuous path for liquid delivered from the self-cleaning system to follow.

### CROSS REFERENCE TO RELATED APPLICATIONS

This application claims the benefit of U.S. Application No. 61/021,130, filed Jan. 15, 2008, and herein incorporated by reference.

### TECHNICAL FIELD

This application relates generally to ovens used for cooking food product and, more specifically, to a rotisserie oven with a self-cleaning feature and a non-gasketed door that limits water egress during cleaning.

### BACKGROUND

Various types of ovens are used for cooking food product. Rotisserie ovens are commonly used in the retail environment to cook chickens and other food products in a manner that permits store customers to view the food product during cooking. Rotisserie style cooking tends to result in grease, juices and food particles within the oven that require the oven to be cleaned regularly.

Including a self-cleaning feature in a rotisserie oven creates a need for adequate door sealing to prevent water egress during cleaning. However, typical gaskets are not designed for operation in such a caustic and hot environment. It would be desirable to provide a self-cleaning rotisserie oven (or other type of self-cleaning oven) with a labyrinth door seal arrangement that eliminates the need for a gasket.

### SUMMARY

In certain aspects, a rotisserie oven includes a self-cleaning system that sprays liquid and an access door configuration with a labyrinth that limits egress of cleaning water as well as preventing heat from escaping the cooking chamber.

In an aspect, a self-cleaning rotisserie oven including an oven cabinet including an internal cooking chamber with an access opening. The oven cabinet includes an access opening frame about the access opening. A self-cleaning system is provided for cleaning the cooking chamber with a liquid. A rotor is located within the cooking chamber. A door is mounted on the oven cabinet. The door spanning the access opening with the door in a closed configuration and providing access to the cooking chamber when in an open configuration. With the door in the closed configuration, the door including a plate extending inwardly toward the oven chamber. The plate is located to an interior side of a lip extending outwardly from the access opening frame and toward the door thereby defining a tortuous path for liquid delivered from the self-cleaning system to follow.

In another aspect, a self-cleaning rotisserie oven includes an oven cabinet including an internal cooking chamber with an access opening. The oven cabinet includes an access opening frame about the access opening. A self-cleaning system is provided for cleaning the cooking chamber with a liquid. A rotor is located within the cooking chamber. A door is mounted on the oven cabinet. The door spans the door frame with the door in a closed configuration. The door provides access to the cooking chamber when in an open configuration. A door cooling system includes an air outlet above the door configured to direct air across an outer surface of the door to cool the door.

In another aspect, a method of inhibiting leaking of a self-cleaning rotisserie oven including an oven cabinet including an internal cooking chamber with an access opening, the oven cabinet including an access opening frame about the access opening, a self-cleaning system for cleaning the cooking chamber with a liquid and a rotor located within the cooking chamber is provided. The method includes mounting a door to the oven cabinet. The door spans the access opening with the door in a closed configuration. The door provides access to the cooking chamber when in an open configuration. The door is provided with a labyrinth seal such that with the door in the closed configuration the door includes a plate extending inwardly toward the oven chamber. The plate is located to an interior side of a lip extending outwardly from the access opening frame and toward the door thereby defining a tortuous path for liquid delivered from the self-cleaning system to follow.

### BRIEF DESCRIPTION OF THE DRAWINGS

FIG. 1 is a front perspective of a rotisserie system;

FIG. 2 is a front perspective of another embodiment of a rotisserie system;

FIG. 3 is a schematic side view of one embodiment of a cooking chamber;

FIG. 4 shows a floor of a cooking chamber including a spray arm assembly and drain manifolds;

FIG. 5 is a cross-sectional plan view of the right side of a door and oven chamber including a labyrinth seal arrangement;

FIG. 6 is a cross-sectional elevation view of the lower region of an oven door and housing;

FIG. 7 is a cross-sectional plan view of the left side of a door and oven chamber including a labyrinth seal arrangement; and

FIG. 8 is a cross-sectional elevation view of the upper region of an oven door and housing.

### DETAILED DESCRIPTION

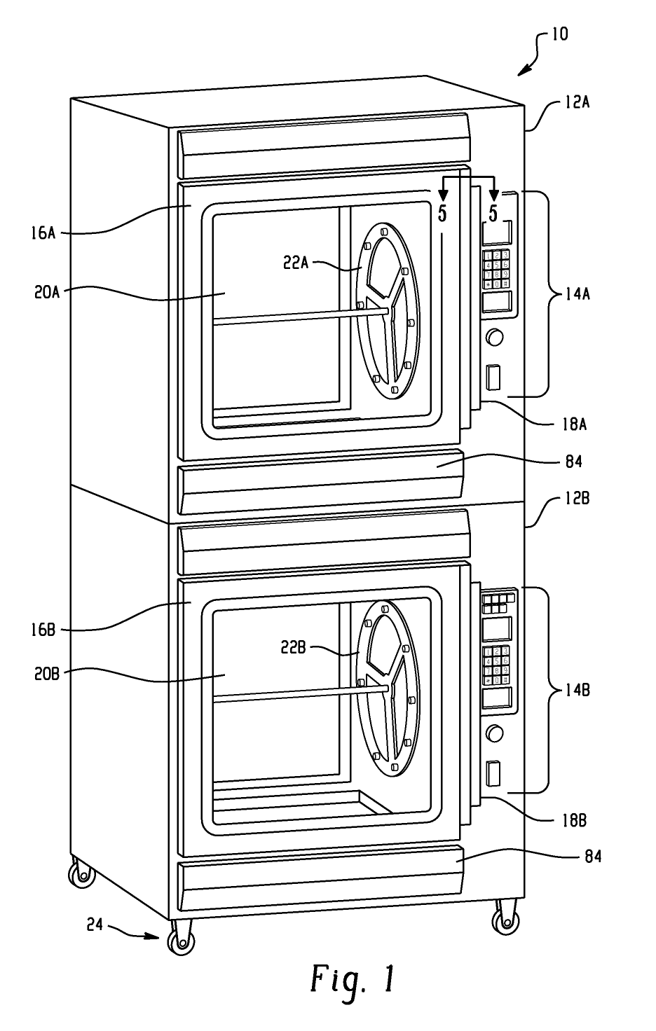

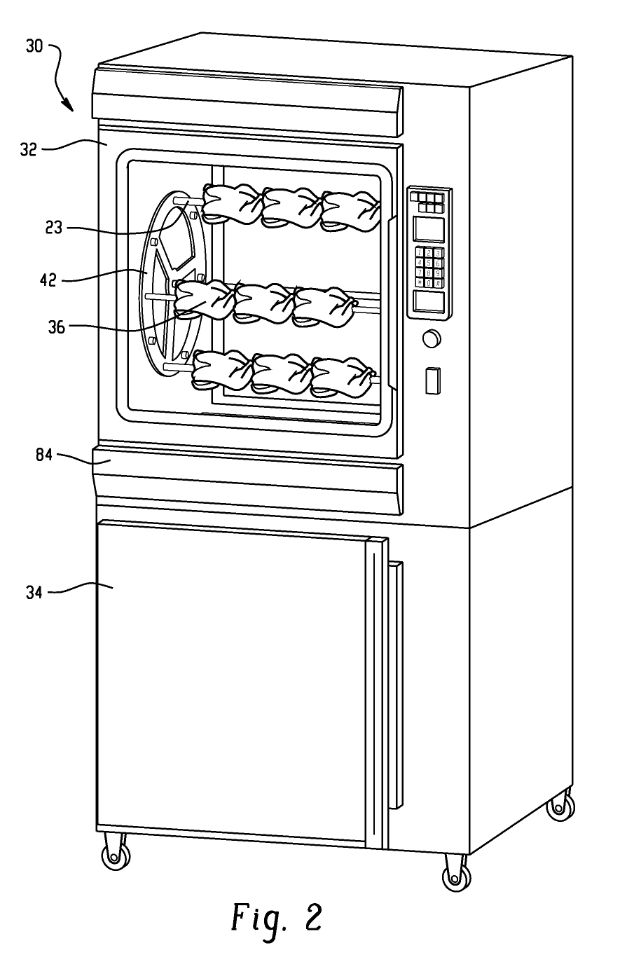

Referring to FIG. 1, a rotisserie system 10 is shown including a rotisserie oven 12A stacked atop another rotisserie oven 12B. Each oven includes a respective control interface 14A, 14B, which may include a variety of components, such as an information display area, a numeric keypad, ON/OFF buttons/keys, function specific buttons/keys, and/or various indicator lights. Each oven includes a vertically hinged access door 16A, 16B with a respective handle 18A, 18B and glass front 20A, 20B for viewing the rotisserie operation. The rear side of the oven may also include a viewing window, and in some cases may be formed by a rear door. A rotor 22A, 22B within each oven is also shown. The rotor 22A and 22B carry an number of spits 23 (FIG. 2) that carry food product. The illustrated system is supported by wheels 24 for ease in repositioning the system, with one or more of the wheels 24 including a lock feature. Referring to FIG. 2, a rotisserie system 30 is shown with a single oven 32 stacked atop a lower cabinet 34. The spit 23 within oven 32 includes birds 36 loaded thereon as per a typical rotisserie cooking operation. In other embodiments, the rotor 22 carries baskets (not shown) that can hold the birds 36.

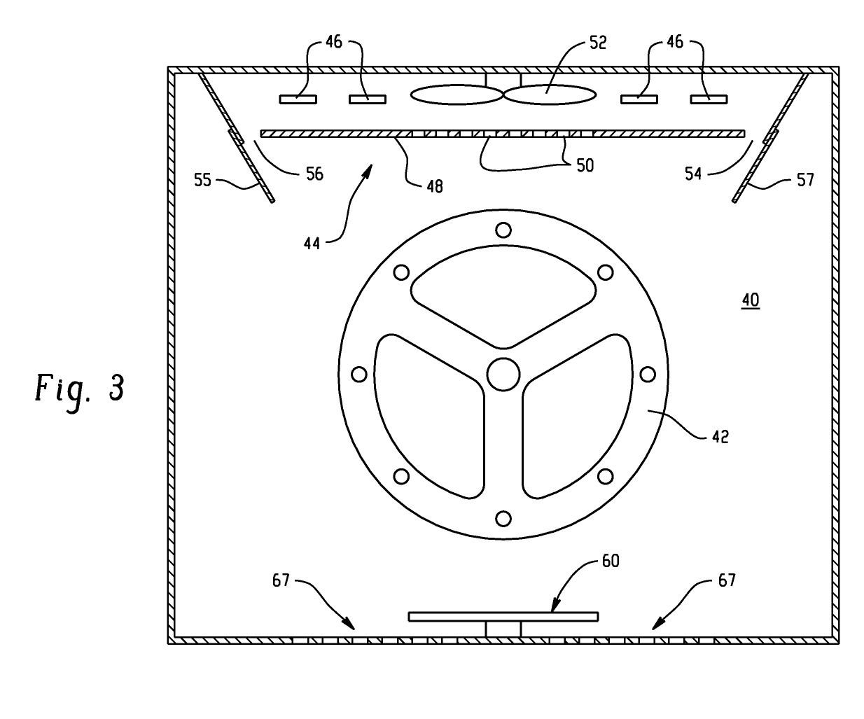

FIG. 3 is a side view layout showing an exemplary oven chamber 40. During rotisserie cooking operations, the rotor 42 rotates as heat is generated by a heating system 44. In the illustrated embodiment, the heating system 44 is formed by heating elements 46 located above an upper plate or shield 48. The plate 48 includes one or more intake openings 50 with associated convection fans 52 arranged to draw air into the openings 50 from the chamber 40. The fans 52 push the air forward and rearward and across the heating elements 46 to pick up heat. The heated air is then directed back into the chamber 40 at forward and rearward slots 54 and 56. Baffles 55 and 57 guide the air inward toward the rotor 42 at the center of the chamber 40 as the heated air passes through the ventilation slots 54 and 56. The space above the plate 48 may include other directional plates or baffles to more effectively produce the forward and rearward air flow.

The rotisserie oven includes a self-cleaning feature that enables the oven to be cleaned during a self-cleaning mode of operation. For this purpose the oven may generally have hook-ups to a source of water and cleaning agent, and may also include a drain path and hook-up to enable the cleaning water to be purged during various points of the cleaning operation. The cleaning operation may include one or more stages, including pre-wash, wash and/or rinse stages. Different cleaning modes (e.g., which may provide different levels of cleaning) may be provided for user selection based upon the user's observation of how clean or dirty the oven is prior to cleaning.

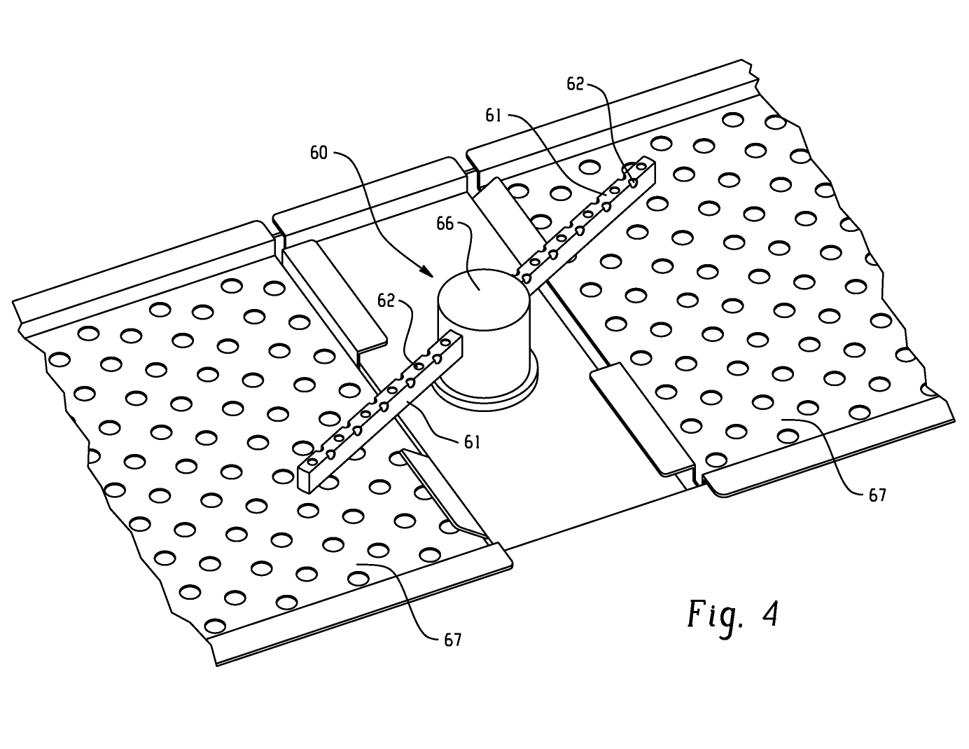

In one implementation the self-cleaning feature includes the use of a spray arm assembly 60, shown in FIG. 3 at a bottom portion of the cooking chamber 40. As shown in FIG. 4, the spray arm assembly 60 includes a rotatable spray arm hub 66 upon which is mounted one or more spray arms 61. Each spray arm 61 includes a multiplicity of nozzle openings 62 for ejecting sprays of water during cleaning, and the force of the ejected water urges each arm 61 to rotate. Water is evacuated from the bottom of the chamber 40 through use of the strainers 67, which lead to a lower sump area where cleaning liquid collects for recirculation via a pump. Other stationary and/or rotating wash arms and/or nozzles could also be located elsewhere within the oven chamber 40 and/or above the plate 48.

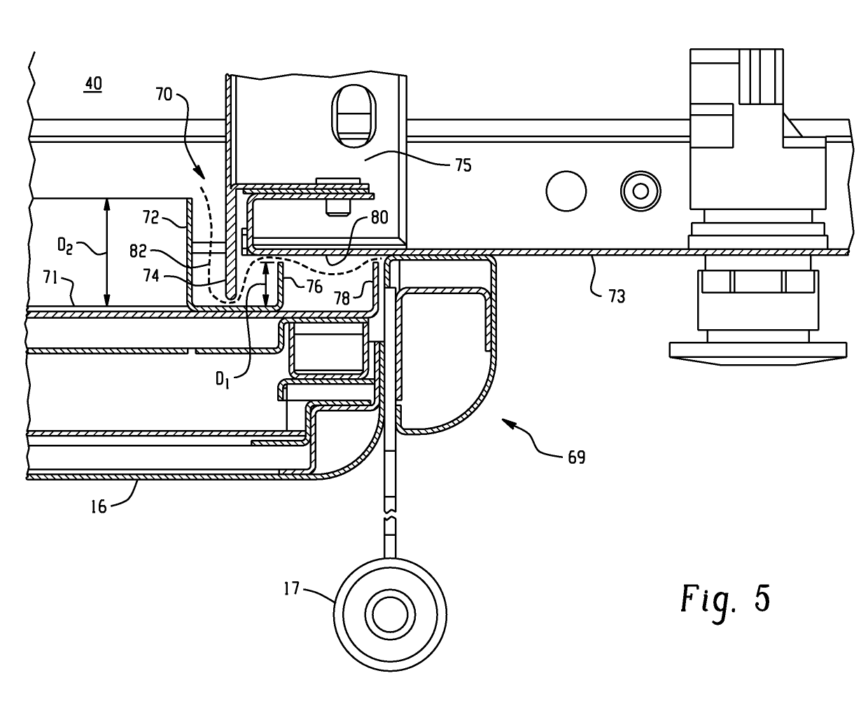

Referring to FIG. 5, a cross-sectional view on an opening side 69 of the door 16 along line 5-5 of FIG. 1 shows a labyrinth seal arrangement 70. The opening side 69 of the door 16 is where the handle 17 is positioned. An interior side 71 of the oven door 16 facing the oven chamber 40 includes an inwardly extending flange/plate 72 that extends generally out of the plane of the door toward the oven chamber. Housing 73 of the oven includes a frame 75 about the cavity access opening with an outwardly extending flange/lip 74 extending generally toward the door and adjacent the oven chamber 40. The interior side 71 of the oven door 16 includes additional inwardly extending flanges/lips 76 and 78 configured to be spaced from, but in close proximity to, the front face 80 of the oven when the door is closed. The lip 76 and plate 72 form a U-shaped recess that receives the lip 74 of the access opening frame 75 when the door is in its closed configuration as shown by FIG. 5. The lips 76 and 78 are both located to an exterior side of the lip 74 away from the oven chamber 40 and both are smaller in protruding depth than the lip 72. The protruding depth D₁ of the lips 76 and 78 may be no more than about 50 percent of the protruding depth D₂ of the lip 72.

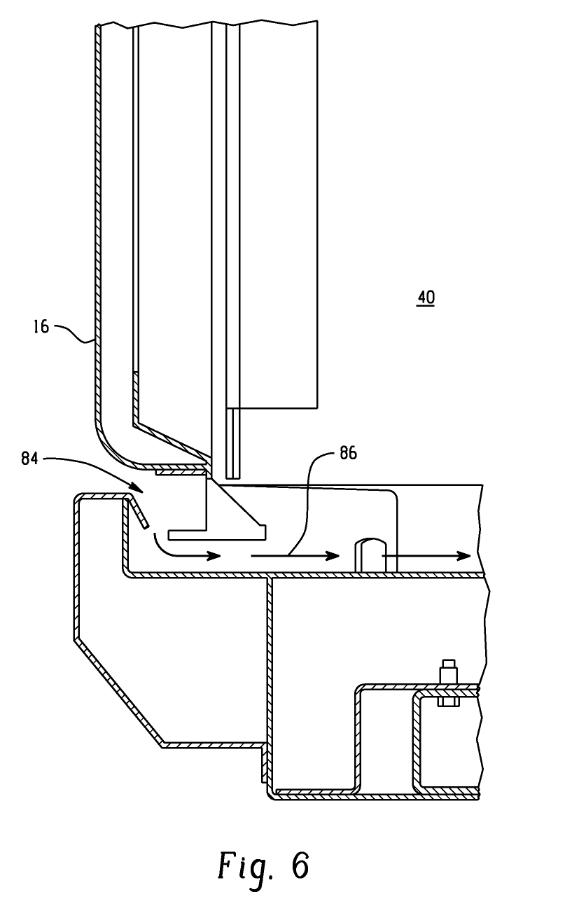

The labyrinth seal arrangement 70 creates a tortuous labyrinth path, with multiple direction changes, as represented by dashed line 82, along which water would have to travel to exit the oven. As a result, water tends to drop under the force of gravity, traveling down the channels formed between the door 16 and oven housing 73, where the water is collected in a sump pan 84 at the bottom of the door as shown in FIG. 6. The water is directed back into the oven as reflected by arrow 86, where it collects in a sump at the bottom of the oven chamber 40 for recirculation through the spraying system. In some embodiments, the sump pan 84 is slanted downwardly such that water tends to flow back toward the oven chamber 40. Because the door components that form the labyrinth path have no direct contact with the face of the oven chamber 40, the resulting air space can provide a thermal break to reduce heat transfer to the outer surface of the door 16. This can reduce door temperatures while minimizing heat loss. Flanges/lips 72 and 76 may be formed of a common U-shaped metal channel as illustrated, but could also be separately formed pieces.

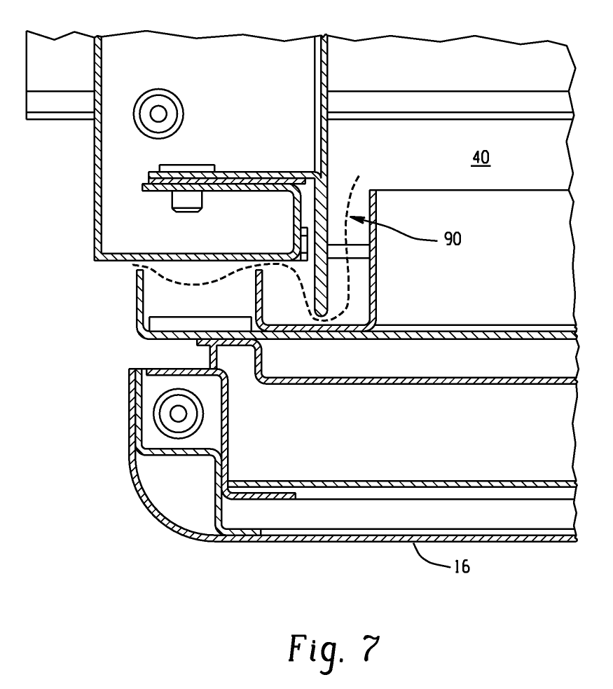

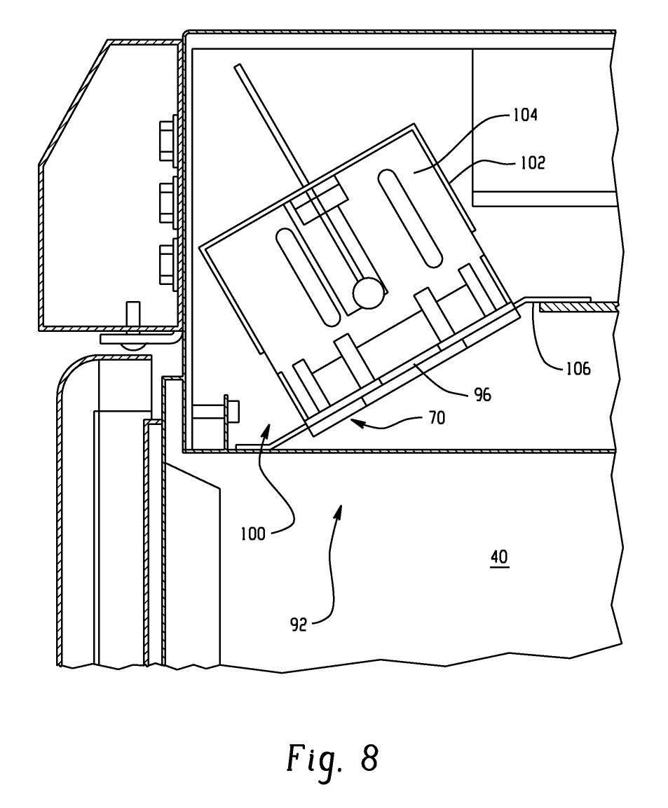

A similar labyrinth arrangement 90 may be located at the left side (pivoting side) of the door per FIG. 7, and at the top of the door as per 92 of FIG. 8. As shown in FIG. 1, the sump pan 84 extends across the width of the door to collect water from both sides of the door 16, as well as along the base of the door.

As shown in FIG. 8, the oven may also include a door cooling arrangement in which a housing facade 96 includes downward facing openings 98 that are positioned so that an air flow 100 is directed downward over the exterior surface of the door. The air flow 100 acts to cool the exterior surface temperature of the door 16, particularly at the upper extent of the door that tends to be hotter. The air flow may be produced by fans, shown schematically as member 102, located atop the oven in an electronics control space 104, so that the air utilized to cool the surface of each door is the same air that is used to cool the electronics within space.

It is to be clearly understood that the above description is intended by way of illustration and example only, is not intended to be taken by way of limitation. For example, The rotisserie oven can be stacked as shown in FIG. 1, located on a stand as shown by FIG. 2, located atop a counter, located atop a combination oven, located atop a convection oven, etc. Accordingly, other changes and modifications are possible.

What is claimed is:

1. A self-cleaning rotisserie oven, comprising:
an oven cabinet including an internal cooking chamber with an access opening, the oven cabinet including an access opening frame about the access opening;
a self-cleaning system for cleaning the cooking chamber with a liquid;
a rotor located within the cooking chamber; and
a door mounted on the oven cabinet, the door spanning the access opening with the door in a closed configuration, the door providing access to the cooking chamber when in an open configuration,
with the door in the closed configuration the door including a plate extending inwardly toward the oven chamber, the plate being located to an interior side of a lip extending outwardly from the access opening frame and toward the door thereby defining a tortuous path for liquid delivered from the self-cleaning system to follow.

2. The self-cleaning rotisserie oven of claim 1, wherein the lip extending outwardly from the access opening frame is a first lip, the door including a second lip extending inwardly toward the frame and being located to an exterior side of the first lip.

3. The self-cleaning rotisserie oven of claim 2, wherein the plate and the second lip define part of a vertically extending, U-shaped channel that receives the first lip.

4. The self-cleaning rotisserie oven of claim 3, wherein the door includes a third lip extending inwardly toward the frame and being located to an exterior side of the second lip.

5. The self-cleaning rotisserie oven of claim 4 further comprising a sump pan positioned below the door to collect liquid that falls from the tortuous path.

6. The self-cleaning rotisserie oven of claim 5, wherein the sump pan is arranged and configured to direct the liquid toward the oven chamber away from the door.

7. The self-cleaning rotisserie oven of claim 1 further comprising a door cooling system comprising an air outlet above the door configured to direct air across an outer surface of the door to cool the door.

8. The self-cleaning rotisserie oven of claim 7 further comprising an electronics control space above the cooking chamber within the oven cabinet, the air directed across the outer surface of the door first passes through the electronics control space for cooling thereof.

9. The self-cleaning rotisserie oven of claim 1, wherein the door defines a plane than spans the door frame and the plate extends inwardly toward the oven chamber and out of the plane of the door at an opening side of the door.

10. A self-cleaning rotisserie oven, comprising:
an oven cabinet including an internal cooking chamber with an access opening, the oven cabinet including an access opening frame about the access opening;
a self-cleaning system for cleaning the cooking chamber with a liquid;
a rotor located within the cooking chamber;
a door mounted on the oven cabinet, the door spanning the door frame with the door in a closed configuration, the door providing access to the cooking chamber when in an open configuration; and
a door cooling system comprising an air outlet above the door configured to direct air across an outer surface of the door to cool the door.

11. The self-cleaning rotisserie oven of claim 10 further comprising an electronics control space above the cooking chamber within the oven cabinet, the air directed across the outer surface of the door first passes through the electronics control space for cooling thereof.

12. The self-cleaning rotisserie oven of claim 10 further comprising
a labyrinth seal extending vertically along an opening side of the door defining a tortuous leak path; and
a sump pan positioned below the door to collect liquid that falls from the tortuous leak path.

13. The self-cleaning rotisserie oven of claim 12, wherein the sump pan is arranged and configured to direct the liquid toward the oven chamber away from the door.

14. A method of inhibiting leaking of a self-cleaning rotisserie oven including an oven cabinet including an internal cooking chamber with an access opening, the oven cabinet including an access opening frame about the access opening, a self-cleaning system for cleaning the cooking chamber with a liquid and a rotor located within the cooking chamber, the method comprising:
mounting a door to the oven cabinet, the door spanning the access opening with the door in a closed configuration, the door providing access to the cooking chamber when in an open configuration; and
providing the door with a labyrinth seal such that with the door in the closed configuration the door including a plate extending inwardly toward the oven chamber, the plate being located to an interior side of a lip extending outwardly from the access opening frame and toward the door thereby defining a tortuous path for liquid delivered from the self-cleaning system to follow.

15. The method of claim 14 further comprising collecting liquid falling from the labyrinth seal in a sump pan positioned below the door.

16. The method of claim 15 further comprising directing the liquid collected in the sump pan toward the oven chamber away from the door.

17. The method of claim 14 further comprising cooling the door using a door cooling system comprising an air outlet above the door configured to direct air across the door.

18. The method of claim 17 further comprising cooling an electronics control space above the cooking chamber within the oven cabinet using the door cooling system.
